(19) United States
(12) Patent Application Publication
(10) Pub. No.: US 2006/0011370 A1
(43) Pub. Date: Jan. 19, 2006

(54) Damping device

(75) Inventors: Heino Foersterling, Lohr (DE); Peter Manecke, Frammersbach (DE)

Correspondence Address: OLIFF & BERRIDGE, PLC, P.O. BOX 19928, ALEXANDRIA, VA, 22320, US

(73) Assignee: BOSCH REXROTH AG, STUTTGART (DE)

(21) Appl. No.: 10/530,570

(22) PCT Filed: Sep. 18, 2003
(86) PCT No.: PCT/DE03/03110

§ 371 Date: Apr. 7, 2005

(30) Foreign Application Priority Data
Oct. 28, 2002 (DE) 102 50 207.2

(51) Int. Cl. H02G 7/14

(52) U.S. Cl. 174/42

(57) ABSTRACT

What is disclosed is a a damping device, in particular for cable-supported structures such as, e.g., cable-stayed bridges, stadium roofs, guyed towers, comprising a differential cylinder, two hydraulic units, and an electric motor, wherein during damping the one hydraulic unit acts as a motor, and the second hydraulic unit acts as a pump, with surplus hydraulic energy being convertible into electric energy through the intermediary of the electric motor.

The invention relates to a damping device in particular for cable-supported structures such as, e.g., cable-stayed bridges, stadium roofs, guyed towers, in accordance with the preamble of claim 1.

The expression “damping device” is understood to designate a hydraulic linear axis for semi-active or active damping, where essentially only control energy is introduced.

Cable-stayed bridges are presently considered the most economical solution for spans of about 150 m to 600 m. Most recent developments show that spans of even up to 1000 m are possible.

The material-saving, slim realization of large-size cable-stayed bridges does result in a construction that is attractive in terms of architecture, however the low internal damping results in structures that are extremely sensitive to vibrations. Particularly due to stimulation by wind, vibration amplitudes making it necessary to close a bridge for traffic may be reached. The strain to the components of the structure (deck and cables) is enormous, and the resulting follow-up costs are considerable.

The effect of known passive dampers on deck vibrations is not satisfactory. Active damping devices specifically provided in the terminating anchorages of the cable stays, on the other hand, bring about a significant reduction of the vibration amplitude. The known realizations do however—in addition to the demand of electrical actuation energy—have a considerable energy consumption.

It is an object of the present invention to furnish a damping device which, at minimum energy demand and a reduced size of the active element, exhibits improved response and thus damping characteristics, and permits the use of low-cost sensory equipment.

This object is achieved through a damping device having the features in accordance with claim 1.

The damping device of the invention comprises a differential cylinder, two hydraulic units with variable pivoting angles, an electric motor associated with the hydraulic units, a hydraulic accumulator, and a tank. One hydraulic unit is arranged in the pressure medium flow path between the tank and a piston rod-side ring chamber, and the second hydraulic unit is positioned in the pressure medium flow path between the ring chamber and a cylinder chamber of the differential cylinder.

Instead of the adjustable hydrostatic or hydrostatic displacement machines it is also possible to employ hydrostatic displacement machines having a constant displacement volume. The variable flow required for the desired cylinder velocity is then obtained through the intermediary of a variable-speed electric motor.

As a result of this arrangement of the hydraulic units in accordance with the invention, these are supported against each other such that in the quasi-static condition, if the hydraulic units are designed accordingly (in accordance with the selected pressure conditions), the remaining torque is zero (when neglecting friction and other losses) and the electric motor thus determines the rotational speed nearly free from torque. One of the hydraulic units acts as a motor and drives the second hydraulic unit acting as a pump.

If, as a result of the vibrations, the damping device is subjected to dynamic forces, a higher pressure difference acts at the hydraulic unit operating as a motor, while the hydraulic unit operating as a pump has to deliver against a lower pressure difference. This surplus energy is—where it exceeds the frictional and other losses resulting in the power flow—absorbed by the electric motor and may be fed into the electric mains.

The electric motor is basically only necessary in order to activate the damping device at a low vibrational excitation, to predetermine the rotational speed, or to make the surplus power usable as electricity, or compensate for friction losses.

In a preferred embodiment, the differential cylinder is fixedly mounted through its piston on a terminating anchorage of a cable-stayed bridge, wherein its cylinder jacket may be shifted in the longitudinal direction of the piston. A cable stay of the cable-stayed bridge is secured to the cylinder jacket, so that through suitable actuation of the differential cylinder, the vibrations acting in the structure, or the dynamic forces accordingly acting in the cable stay, are attenuated by longitudinal movement of the cylinder jacket—in accordance with damping law—whereby it is possible to avoid uncontrolled tensions inside the structure.

The longitudinal movement of the cylinder jacket resulting from external loads is made possible by adjusting the pivoting angles of the hydraulic units. The pivoting angles may be adjusted such that the moving velocity of the cylinder jacket is proportional to the external loads. In other words, a high load necessitates a large pivoting angle, so that high pressure medium flows may be realized, whereas low loads necessitate small pivoting angles, so that low pressure medium flows are possible.

In one embodiment, the cylinder jacket of the differential cylinder is fixedly mounted, and the piston of the differential cylinder is guided in an axially displaceable manner.

In another embodiment, the adjustment of the pivoting angles or displacement volumes is carried out in accordance with a pressure signal from a pressure transducer arranged in the ring chamber or cylinder chamber.

In the static condition (stroke=0), a bias of the cable stay above the pressures prevailing in the ring chamber and cylinder chamber is set. Ideally the pressure in the cylinder chamber receiving the static cable load is designed for the maximum admissible system pressure. In the ring chamber of the differential cylinder approximately half the system pressure is desirable.

Another embodiment provides a pressure transducer in the cylinder chamber and/or in the range of the hydraulic accumulator for measurement and for adaptation of the hydraulic accumulator pressure and of the hydrostatic accumulator charge to the respective static load.

In one embodiment, the hydraulic accumulator is integrated into the differential cylinder, whereby a compact design is realized.

In another embodiment, the ring chamber of the differential cylinder is sealed against the environment and/or the cylinder chamber through the intermediary of a gap seal formed across an annular gap between piston-side and cylinder jacket-side surfaces.

In a preferred embodiment, the annular gap for sealing of the ring chamber against the external environment opens into a leakage port, wherein at least one sealing member for sealing the annular gap against the atmosphere is provided beyond the leakage port.

It is particularly advantageous in a like gap seal that the friction is reduced to a minimum, and cost-intense and high pressure seals that are susceptible to trouble may be omitted.

Other advantageous embodiments of the invention are subject matters of further subclaims.

Hereinafter two preferred embodiments shall be explained in more detail by referring to schematic representations, wherein:

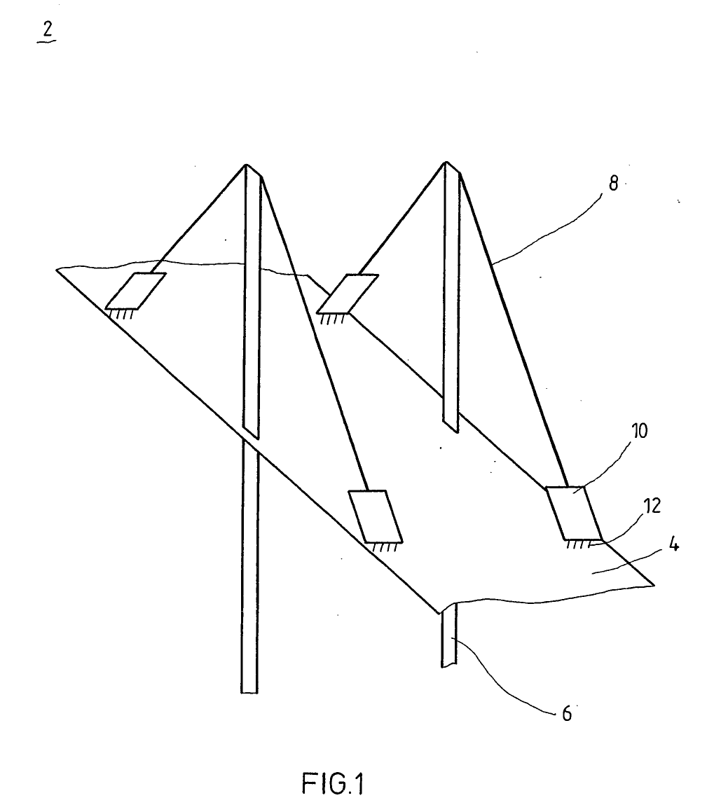

FIG. 1 is a schematic view of a cable-stayed bridge,

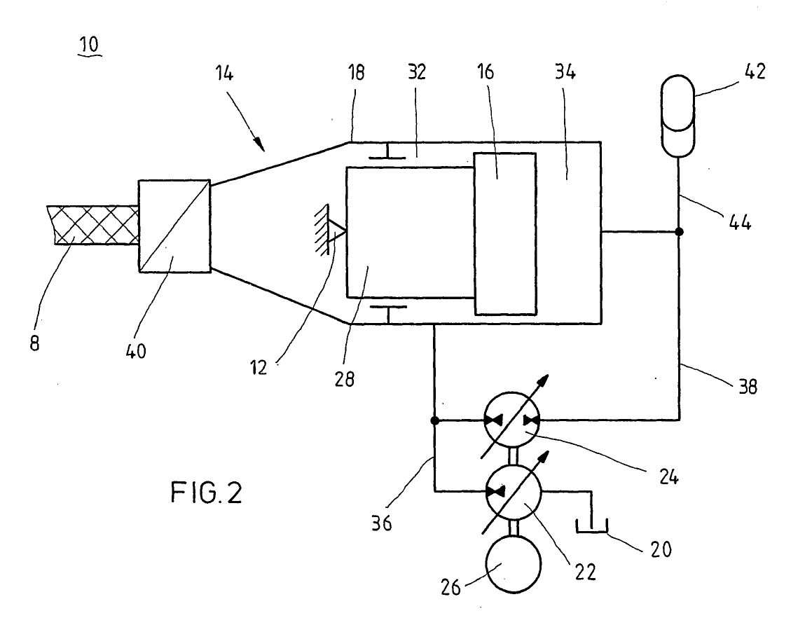

FIG. 2 is a longitudinal sectional view of an embodiment in accordance with the invention which includes an external hydraulic accumulator,

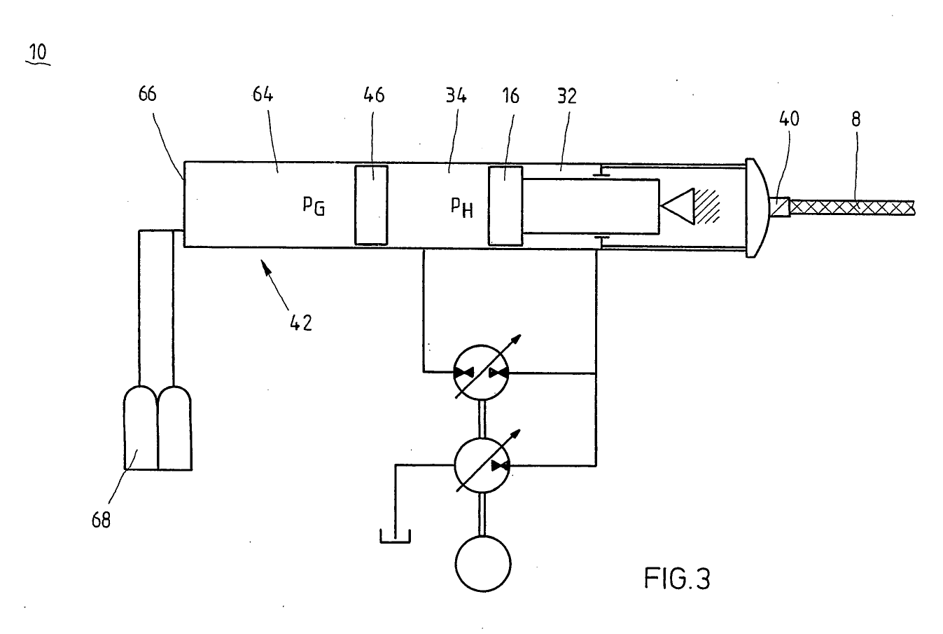

FIG. 3 is a longitudinal sectional view of an embodiment of the invention having a hydraulic accumulator integrated into the differential cylinder, and

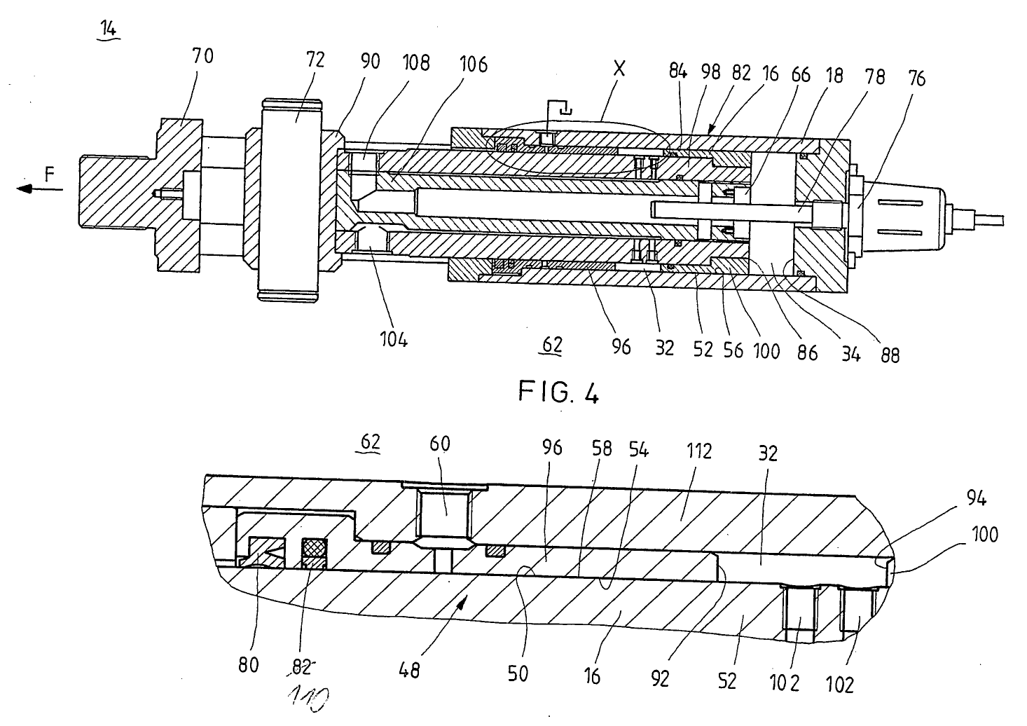

FIG. 4 is a longitudinal sectional view of a differentia cylinder having gap seals in accordance with the invention.

FIG. 1 shows a cable-stayed bridge 2 having one roadway 4 that is supported through the intermediary of main pylons 6. In order to reduce the loads acting on the main pylons 6, the roadway 4 is suspended on cable stays 8 that are supported by the main pylons 6. The cable stays 8 are mounted via damping devices 10 on terminating anchorages 12 of the roadway 4, so that deck vibrations may be attenuated.

FIG. 2 shows a longitudinal sectional view of a preferred embodiment of a damping device 10. The damping device 10 has a differential cylinder 14, two hydraulic units 22, 24, an electric motor 26, a hydraulic accumulator 42, and a tank 20.

The differential cylinder 14 includes a stepped piston 16 which divides the space formed by the cylinder jacket 18 into two pressure chambers—a piston rod-side ring chamber 32 and a cylinder chamber 34.

The piston 16 of the differential cylinder 14 is fixedly mounted on the terminating anchorage 12 via its radially recessed part 28—hereinafter referred to as a piston rod—so that a stroke movement is brought about by a longitudinal movement of the cylinder jacket 18. As the piston 16 is clamped hydraulically on either side thereof, pressure medium is displaced from the one pressure chamber 32, 34 and replenished into the other pressure chamber 34, 32 during each stroke movement, wherein it is possible to compensate deficient or excessive pressure medium volumes through the tank 20.

The cable stay 8 attacks on the cylinder jacket 18, so that the bias of the cable stay 8 is predetermined by the pressures prevailing in ring chamber 32 and cylinder chamber 34.

In kinematic reversal it is, however, also conceivable to fixedly mount the cylinder jacket 18 on the terminating anchorage 12 and to connect the piston rod 28 to the cable stay 8.

The first hydraulic unit 22 is arranged in a first work line 36 between the low pressure-side tank 20 and the high pressure-side ring chamber 32 while being in connection with the electric motor 26. It has a variable displacement volume and may be utilized as a pump or as a motor.

The second hydraulic unit 24 is arranged in a second work line 38 between the high pressure-side ring chamber 32 and the high pressure-side cylinder chamber 34, with the second work line 38 preferably opening into the first work line 36. Correspondingly, like the first hydraulic unit 22 the second hydraulic unit 24 also has a variable displacement volume, is furthermore in connection with the electric motor 26, and may be utilized as a pump or as a motor.

Both hydrostatic or hydrostatic displacement machines 22, 24 convey in two directions during vibration damping, wherein the first hydraulic unit 22 is high pressure resistant only on one side, i.e., on the annular chamber side, and the other side, i.e., the tank side, is subjected to low pressure, while the second hydraulic unit 24 has to be high pressure resistant on both sides, i.e., on the annular chamber side and on the cylinder chamber side, and the direction of the pressure difference may also be reversed in accordance with a 4-quadrant operation.

The displacement volumes of the hydraulic units 22, 24 may be adjusted in accordance with the signal from a load cell 40. The load cell 40 is arranged in the area of the connection cable stay 8—cylinder jacket 18 and associated to a control loop of the hydraulic units 22, 24. It detects the loads acting on the cable stay 8 and in the process passes the detected tensile strains, or forces, on to the control loop, so that the latter adjusts the pivoting angles of the hydraulic units 22, 24 in accordance with these external loads.

A different embodiment provides, instead of the cost-intense force measurement, to utilize the pressure prevailing in the ring chamber 32 or cylinder chamber 34 as a control quantity of the control loop. This may be achieved, e.g., with the aid of a pressure transducer (not represented) arranged in the ring chamber 32 or cylinder chamber 34.

Moreover a hydraulic accumulator 42 is provided which is connected with the second work line 38 and with the cylinder chamber 34 through the intermediary of a third work line 44, so that the pressure in the cylinder chamber 34 becomes largely independent of the cylinder stroke, and the pre-set pressure prevails permanently.

Accumulator charging and control of the accumulator pressure of the hydraulic accumulator 42 may advantageously be achieved through mutual trimming of the displacement volumes of the hydraulic units 22, 24. To this end a pressure transducer or pressure measurement transformer is provided which is preferably arranged in the hydraulic accumulator port or in the work line 38 or in the cylinder chamber 34, respectively.

The electric motor 26 is in operative connection with the two hydraulic units 22, 24, wherein it may both be used as a drive mechanism for the hydraulic units 22, 24 and may also be driven by the hydraulic units 22, 24 in the manner of a generator to thus act as a brake. For example by driving the hydraulic units 22, 24 the pre-set pressures may be adjusted in the pressure chambers 32, 34, and the hydraulic accumulator 42 may be charged. It is, however, also possible in operation for damping to convert the hydraulic energy generated by the first hydraulic unit 22 or the second hydraulic unit 24 into electric energy by setting the electric motor 26 up as a generator.

The operation of this above described arrangement of the invention shall in the following be described in more detail:

In the quasi-static condition (stroke=0), the damping device 10 is balanced, or in a rest position. Here preferably a pressure twice as high as in the ring chamber 32 is set in the cylinder chamber 34, so that, for instance, the first and second hydraulic units 22, 24 are subjected to a same pressure difference. As no vibration loads act on the cable stay 8, force changes are not measured by the load cell 40. The pivoting angles of the hydraulic units 22, 24 are in their basic position, i.e., pivoting angle=0.

In the vibrating condition (stroke≠0), dynamic forces act in the cable stay 8 due to the vibrations, whereby the balance is disturbed. Here it is necessary to make a fundamental distinction between tensile and “compressive” strains. As only deviations from the static mean value are of relevance for damping regulation (the static loads are already compensated by the pressure bias), a tensile strain hereinafter means that the tensile strain on the cylinder jacket 18 or on the cylinder housing acting in the cable stay 8 as a result of vibrations tends to bring about a pressure increase in the cylinder chamber 34, i.e., hydraulic medium is displaced from there into the hydraulic accumulator 42, whereas this results in a pressure reduction in the ring chamber 32. On the other hand, this means that tensile strain acting in the cable stay 8 is covered by the pre-set tensile strain. In other words, in the case of a tension the cylinder jacket 18 moves to the left in accordance with the representation of FIG. 1, and in the case of “pressure” to the right.

The load cell 40 detects the occurring tensile strains, wherein in accordance with the signal from the load cell 40 the displacement volumes of the hydraulic units 22, 24 are adjusted such that a stroke of the cylinder jacket 18 is admitted. Pressure medium is displaced via the respective work line 36, 38 from the pressure chamber 32, 34 diminishing in size, with pressure medium being replenished into the enlarging pressure chamber 34, 32 with the aid of the one hydraulic unit 22, 24(pump function). Here the hydraulic unit 22, 24 set up as a pump is driven by the other hydraulic unit 24, 22 (motor).

At an increased tensile strain in the cable stay 8, the cylinder jacket 18 moves to the left in the representation of FIG. 1, so that the cylinder chamber 34 diminishes and the ring chamber 32 increases in size. At the same time the pressure in the ring chamber 32 drops below the pre-set pressure (e.g., <100 bar), while the pressure in the cylinder chamber 34 remains substantially unchanged (e.g., 200 bar) due to the compensating effect of the hydraulic accumulator 42. Pressure medium thus flows from the cylinder chamber 34 via the second hydraulic unit 24 into the ring chamber 32, with the second hydraulic unit 24 being driven by the pressure medium flow and acting as a hydrostatic motor. The latter then drives the first hydraulic unit 22, so that the latter conveys pressure medium from the tank 20 into the ring chamber 32. Thus the first hydraulic unit 22 acts as a pump. As the pressure drop across the second hydraulic unit 24 is greater than the pressure drop across the first hydraulic unit 22, the second hydraulic unit 24 (motor) can generate more power than is required for driving the first hydraulic unit 22, so that an additional consumer may furthermore be driven apart from the first hydraulic unit 22 (pump). This additional consumer is in accordance with the invention the electric motor 26 operated in this arrangement as a generator and thus converts the surplus hydraulic energy of the second hydraulic unit 24 into electric energy, i.e., acts as a brake.

In the event of a tensile strain of the cable stay 8, the first hydraulic unit 22 thus acts as a pump, the second hydraulic unit 24 acts as a motor for the first hydraulic unit 22, and the electric motor 26 optionally acts as a generator, whereby a movement of the cylinder jacket 18 is realized that damps the bridge's vibration.

Upon a movement of the cable stay 8 to the right, the cylinder jacket 18 moves to the right, whereby the cylinder chamber 34 is enlarged and the ring chamber 32 is reduced in size. The pressure in the ring chamber 32 rises (e.g., >100 bar), while the pressure in the cylinder chamber 34 is kept constant through the intermediary of the hydraulic accumulator 42 (e.g., 200 bar). At the same time pressure medium flows from the ring chamber 32 via the first hydraulic unit 22 into the tank 20, so that the latter is driven by the pressure medium flow and acts as a hydrostatic motor. The latter then drives the second hydraulic unit 24, so that it acts as a pump to convey pressure medium from the ring chamber 32 into the cylinder chamber 34. In the process the first hydraulic unit 22 (motor) generates more power than is required for driving the second hydraulic unit 24 (pump), so that an additional consumer might be operated. This additional consumer then in accordance with the invention is the electric motor 26 which acts in this arrangement as a generator and thus converts the surplus hydraulic energy of the first hydraulic unit 22 into electric energy, i.e., acts as a brake.

In the event of a “compressive strain” of the cable stay 8 the first hydraulic unit 22 thus acts as a motor for the second hydraulic unit 24, the second hydraulic unit 24 acts as a pump, and the electric motor 26 optionally acts as a generator, with a movement of the cylinder jacket 18 damping the vibration of the bridge deck being realized in the process.

Thus in accordance with the invention a damping device 10 is furnished that operates in the biased condition substantially without external supply of energy. All the energy necessary for obtaining or compensating the pressures may, in accordance with the realization of the damping device 10 in accordance with the invention, fundamentally be obtained from the vibration energy.

In a preferred embodiment of the differential cylinder 14 (FIG. 3), the hydraulic accumulator 42 is not arranged externally but integrated into the differential cylinder 14 with its accumulator 64. The cylinder jacket 18 is elongated in this embodiment and delimits the accumulator 64 which is separated from the cylinder chamber 34 by a partition 46. In order to furnish additional gas volume, the latter is connected with external compensator reservoirs 68. The partition 46 is subjected on the cylinder chamber side to the pressure pH in the cylinder chamber 34, so that the latter is axially displaced in accordance with the relation between the gas pressure pG and the pressure pH, and the pressure pH in the cylinder chamber 34 is kept largely constant in accordance with the laws of the state quantities of the gas.

Such an arrangement of the hydraulic accumulator 42 has a particularly compact construction. Moreover tubing is simple because a pressure medium line between the hydraulic accumulator 42 and the cylinder chamber 34 is not necessary.

FIG. 4 shows a preferred embodiment of a differential cylinder 14 having a ring chamber 32 that is sealed in accordance with the invention against an external environment 62 and against a cylinder chamber 34. The differential cylinder 14 includes a multi-part piston 16 and a cylinder jacket 18. The differential cylinder 14 has at the free end portion 90 of its piston 16 a reception 72 for supporting the differential cylinder 14 at the terminating anchorage 12, and at the cylinder jacket 18 a reception 70 for securing a cable stay 8.

In order to measure the stroke of the cylinder jacket 18, the differential cylinder 14 has a stroke measuring device 76 that is arranged on the end side of the cylinder jacket 18 and is in operative connection with the piston 16. Moreover the piston 16 comprises an annular element 66 that is in operative connection with a rod-type element 78 arranged on the cylinder jacket 18. In the event of strokes of the cylinder jacket 18, the annular element 66 changes its position relative to the longitudinal axis of the rod-type element 78, so that the stroke may be determined, and a positional regulation of the damping device 10 may be realized.

The ring chamber 32 (detail x) extends radially between a jacket section 52 and an opposed cylinder jacket portion 112 and is axially delimited by opposite end faces 92, 94 of a slide sleeve 96 arranged on the cylinder jacket 18 and of a spacer sleeve 100 arranged on the received end portion 98 of the piston 16. Via radial bores 102 opening into an axial pressure passage (not represented) it is connected with a pressure port 104 for connection of the first work line 36 or of the hydraulic units 22, 24, respectively. In the range of the slide sleeve 96, a leakage port 60 is provided in the cylinder jacket 18.

The cylinder chamber 34 extends radially over the entire internal diameter of the cylinder jacket 18 and is axially delimited by opposed end faces 86, 88 of the cylinder jacket 18 and of the piston 16. It is connected, via a pressure sleeve 106 arranged in the piston 16, with a pressure port 108 for the connection of the second work line 38 or of the second hydraulic unit 24, respectively, and of the hydraulic accumulator 42.

The seal in accordance with the invention of the ring chamber 32 against the external environment 62 and the cylinder chamber 34 is realized with the aid of gap seals 48, 82 having the form of annular gaps 58, 84. The annular gap 58 for sealing of the ring chamber 32 against the external environment 62 is formed between the inner peripheral surface 54 of the slide sleeve 96 and the respective outer circumference portion 50 of the piston 16. The annular gap 58 opens into a leakage port 60. The annular gap 84 for sealing of the ring chamber 32 against the cylinder chamber 34 is formed between the outer circumference portion 52 of the spacer sleeve 100 and the respective opposed inner peripheral portion 112 of the cylinder jacket 18.

In order to achieve sufficient tightness and a sufficiently great pressure reduction through the intermediary of the annular gaps 58, 84, these must be formed to be radially correspondingly narrow and axially correspondingly long.

In accordance with the invention, beyond the leakage port 60 radial sealing members or stripping members 80, 110 are provided that seal the annular gap 58 against the external environment 62. Owing to the low pressure gradient between the pressure of the external environment 62 and the pressure of the pressure medium, only low-pressure seals 80, 110 are required in the range of the leakage port 60.

Besides the omission of high-pressure seals for sealing of the ring chamber 32, what is particularly positive about the gap seals 48, 82 of the invention is the fact that the friction between opposed piston-side surfaces 50, 54 and cylinder jacket-side surfaces 52, 56 is reduced, so that such a differential cylinder 14 exhibits a better responsiveness than comparable differential cylinders 14 with conventional seals.

What is disclosed is a a damping device, in particular for cable-supported structures such as, e.g., cable-stayed bridges, stadium roofs, guyed towers, comprising a differential cylinder, two hydraulic units, and an electric motor, wherein during damping the one hydraulic unit acts as a motor, and the second hydraulic unit acts as a pump, with surplus hydraulic energy being convertible into electric energy through the intermediary of the electric motor.

### List Of Reference Symbols

2 cable-stayed bridge
4 roadway
6 main pylon
8 cable stay
10 damping device
12 terminating anchorage
14 differential cylinder
16 piston
18 cylinder jacket
20 tank
22 first hydraulic unit
24 second hydraulic unit
26 electric motor
28 piston rod
32 ring chamber
34 cylinder chamber
36 first work line
38 second work line
40 load cell
42 hydraulic accumulator
44 third work line
46 partition
48 gap seal
50 outer circumference portion
52 outer circumference surface
54 inner circumference portion
56 inner circumference portion
58 annular gap
60 leakage port
62 external environment
64 accumulator
66 annular element
68 compensator reservoir
70 reception
72 reception
74 pressure passage
76 stroke measuring device
78 rod-type element
80 sealing member (low-pressure seal)
82 gap seal
84 annular gap
86 end face
88 end face
90 free end portion
92 end face
94 end face
96 slide sleeve
98 received end portion
100 spacer sleeve
102 bores
104 pressure port
106 pressure sleeve
108 pressure port
110 sealing member
112 cylinder jacket portion

1-13. (canceled)

14. A damping device, in particular for cable-stayed bridges, comprising a differential cylinder, a tank, two hydraulic units, a hydraulic accumulator, and an electric motor associated to the hydraulic units, characterized in that a hydraulic unit is arranged in the pressure medium flow path between the tank and a piston rod-side ring chamber and the second hydraulic unit in the pressure medium flow path between the ring chamber and a cylinder chamber.

15. The damping device in accordance with claim 14, characterized in that the hydraulic units each have a variable displacement volume.

16. The damping device in accordance with claim 14, characterized in that the electric motor drives the hydraulic units.

17. The damping device in accordance with claim 15, characterized in that a pressure transducer for measuring a pressure prevailing in the ring chamber and/or in the cylinder chamber is provided for adjusting the pivoting angles or displacement volumes of the hydraulic units.

18. The damping device in accordance with claim 15, characterized in that in the cylinder chamber and/or in the range of the hydraulic accumulator a pressure transducer is provided for measuring an accumulator pressure and the accumulator charge of the hydraulic accumulator and for adaptation to the static load.

19. The damping device in accordance with claim 14, characterized in that the electric motor is adapted to be driven through the intermediary of at least one of the hydraulic units and thus may be utilized as a generator.

20. The damping device in accordance with claim 14, characterized in that in the quasi-static condition a pressure approximately twice as high as in the ring chamber prevails in the cylinder chamber.

21. The damping device in accordance with claim 14, characterized in that the piston of the differential cylinder is fixedly mounted, and the cylinder jacket of the differential cylinder is guided in an axially displaceable manner.

22. The damping device in accordance with claim 14, characterized in that the cylinder jacket of the differential cylinder is fixedly mounted, and the piston of the differential cylinder is guided in an axially displaceable manner.

23. The damping device in accordance with claim 14, characterized in that the hydraulic accumulator is integrated into the differential cylinder.

24. The damping device in accordance with claim 14, characterized in that the ring chamber is sealed against the external environment and/or against the cylinder chamber through the intermediary of a gap seal.

25. The damping device in accordance with claim 24, characterized in that the gap seal is formed by an annular gap between piston-side surfaces and cylinder jacket-side surfaces.

26. The damping device in accordance with claim 25, characterized in that beyond a leakage port, the annular gap is sealed against the external environment through the intermediary of at least one sealing member.
